(19) United States
(12) Patent Application Publication
(10) Pub. No.: US 2007/0130818 A1
(43) Pub. Date: Jun. 14, 2007

(54) Self hooking ice fishing apparatus

(76) Inventor: Samuel Lloyd Green, Richmond Hill (CA)

Correspondence Address: SAMUEL LLOYD GREEN, 25 WESTWOOD LANE, RICHMOND HILL, ON, L4C 6X4, CA

(21) Appl. No.: 11/324,359

(22) Filed: Jan. 4, 2006

(30) Foreign Application Priority Data
Dec. 12, 2005 (CA) 2,525,505

(51) Int. Cl. A01K 91/10; A01K 97/12

(52) U.S. Cl. 43/15; 43/17

(57) ABSTRACT

An ice fishing apparatus including a main base member, a rod base support member disposed transversely of said member and insertable thereto toward the rear of said member, a rod base hold down member disposed transversely and insertable thereto into the said base at the rear of said base, a trigger and release support member disposed transversely and insertable thereto into the front end of said member.

This invention relates to a novel ice fishing apparatus and more particularly, relates to a unique ice fishing apparatus which minimizes the potential for missing fish catches after they are hooked.

Many States allow for the use of more than one fishing line during ice fishing season. It is arguably difficult for an ice fisher person to attend to more than one line simultaneously. There are currently several signal devices, called “tip-ups” which alert the fisher person when a fish has taken the bait by raising a flag. This requires the fisher person to hurry to the raised flag in order to secure the hook in the mouth of the fish. In order to accomplish the hooking and retrieval of the fish, the fisher person must lift the entire apparatus, and pull up the fish in a hand-over-hand motion because the apparatus has no reel capabilities. In five feet of water this is not problematic. However, in twenty feet of water, the line retrieval process becomes cumbersome and tangles are frequent. In winter conditions, the line can also become stuck to the ice. This invention is designed to allow the fisher person to fish with a rod and reel, eliminating the aforementioned problems.

Additionally, when a fisher person is attending more than one line, there is always the possibility that more than one line will indicate a fish-on situation. This presents the problem of attending more than one line simultaneously, a task which more often than not will result in one or more fish being lost.

The present apparatus of this invention automatically sets the hook when a fish takes the bait, but does not operate prematurely if the fish is only mouthing the bait. The fisher person has the time to attend to other lines unhurriedly. This advantage to the present apparatus represents innovative and important advantages over other ice fishing apparatuses.

Additional advantages of the invention will become apparent in the following detailed descriptions and accompanying drawings in which:

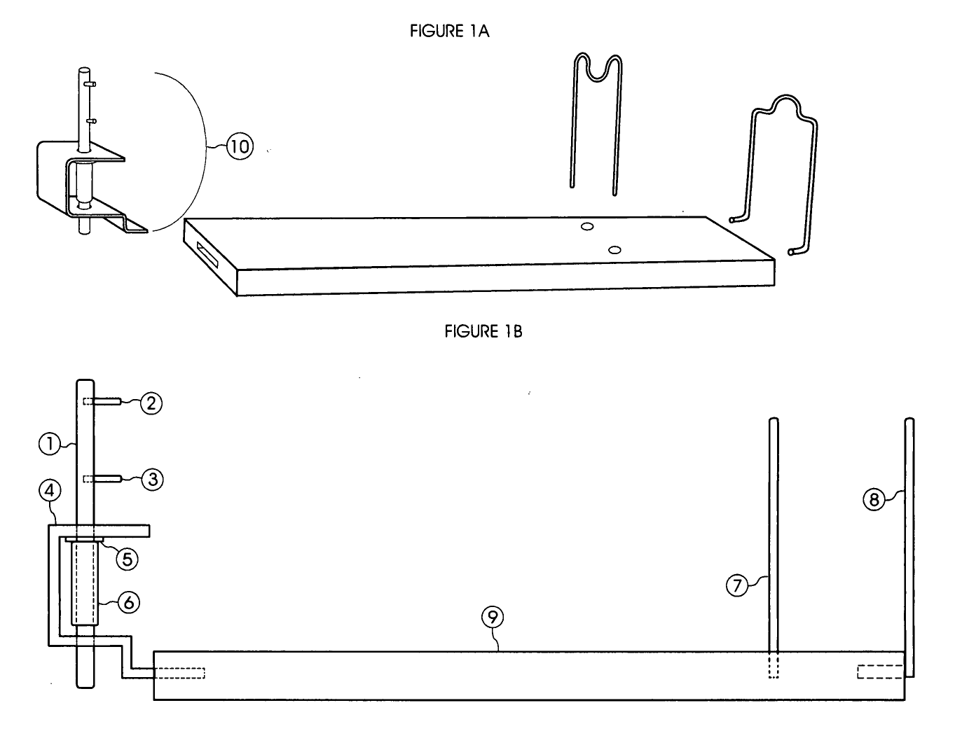

FIG. 1A is a side and top elevation of one form of the present ice fishing apparatus which shows rod base support member, the frontal trigger and release support member, the insertable rod base support member, and the insertable rod base hold down member.

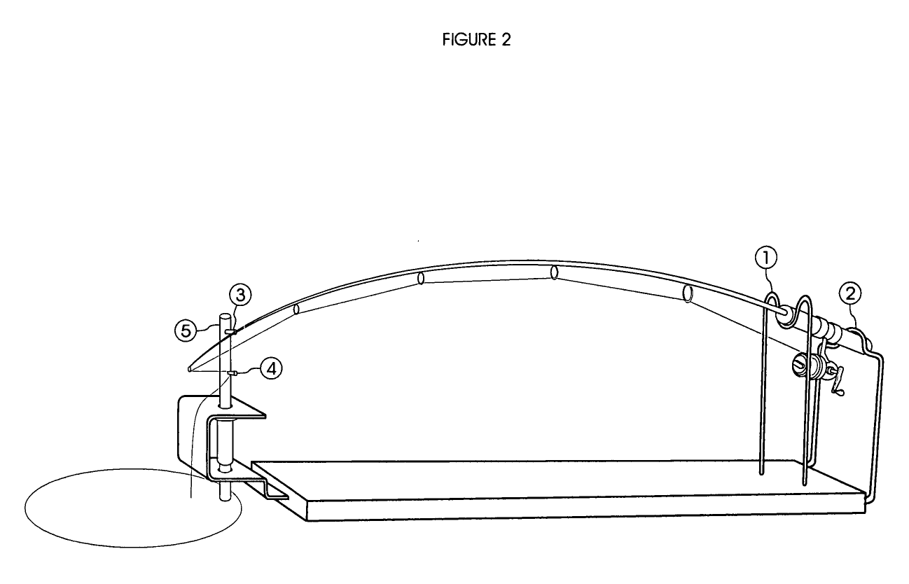

FIG. 2B is a side elevation of one form of the present ice fishing apparatus.

FIG. 2 is a side and top elevation of one form of the present ice fishing apparatus before the trigger has been tripped.

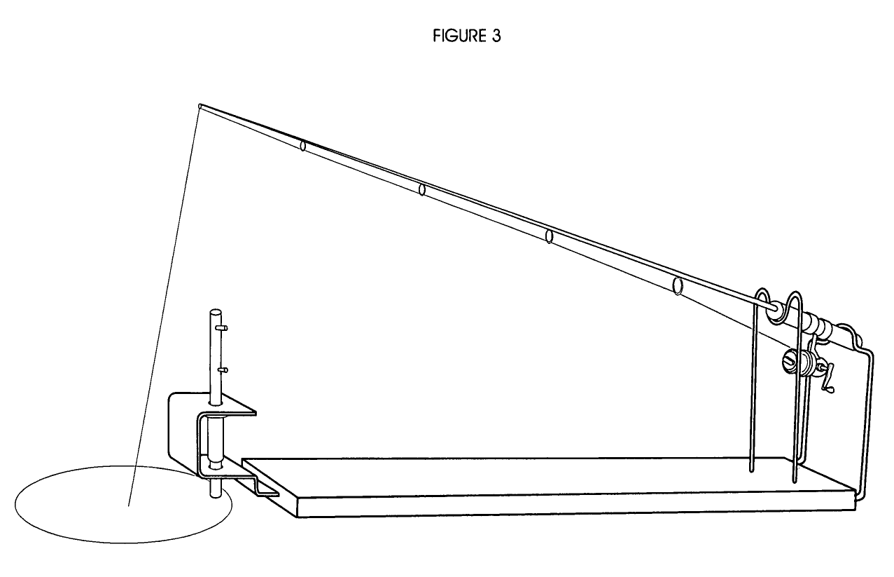

FIG. 3 is a side and top elevation of one form of the present ice fishing apparatus shown in FIG. 1 after the trigger has been tripped.

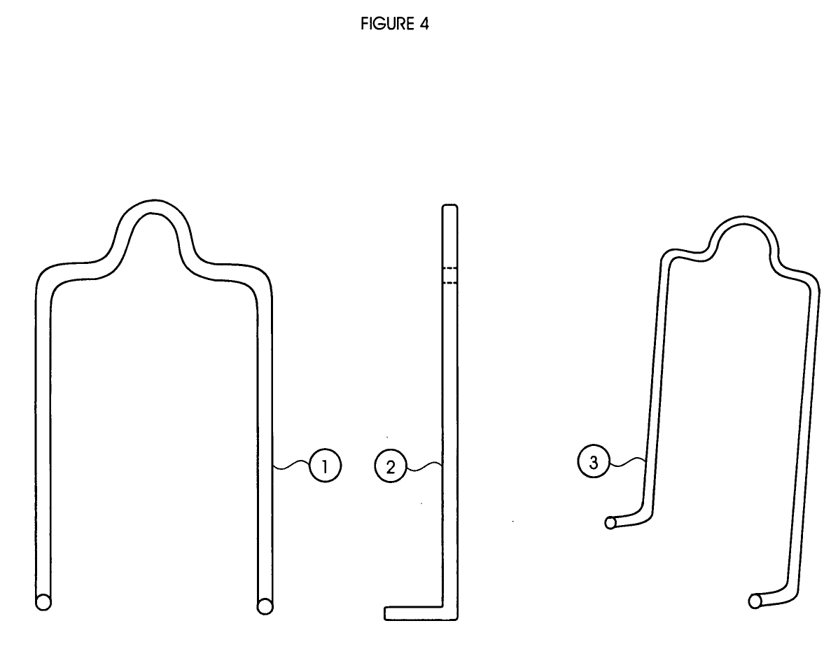

FIG. 4 is a frontal and side and perspective elevations of the insertable rod base hold down member of the present ice fishing apparatus.

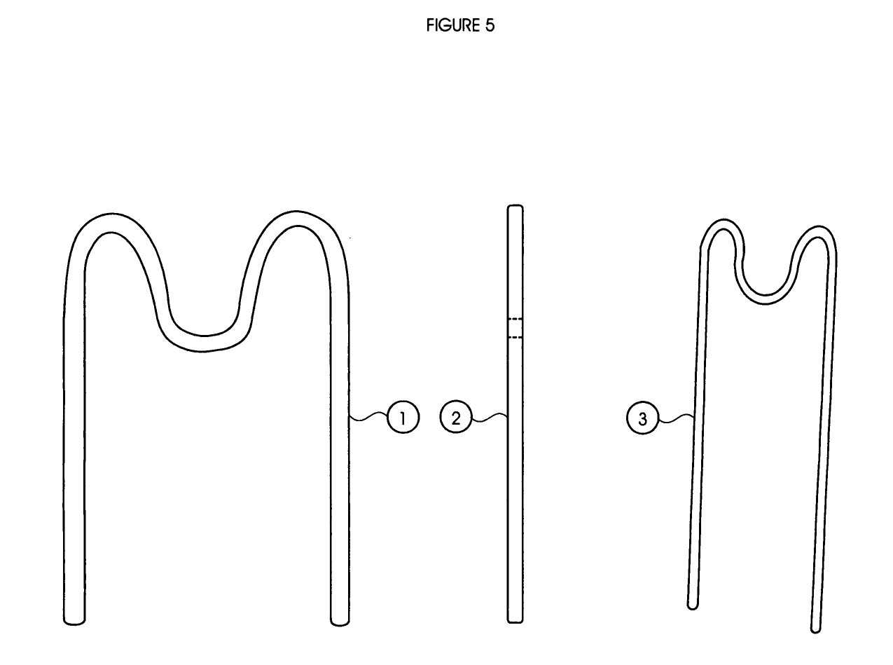

FIG. 5 is a frontal and side and perspective elevations of the insertable rod base support member of the present ice fishing apparatus.

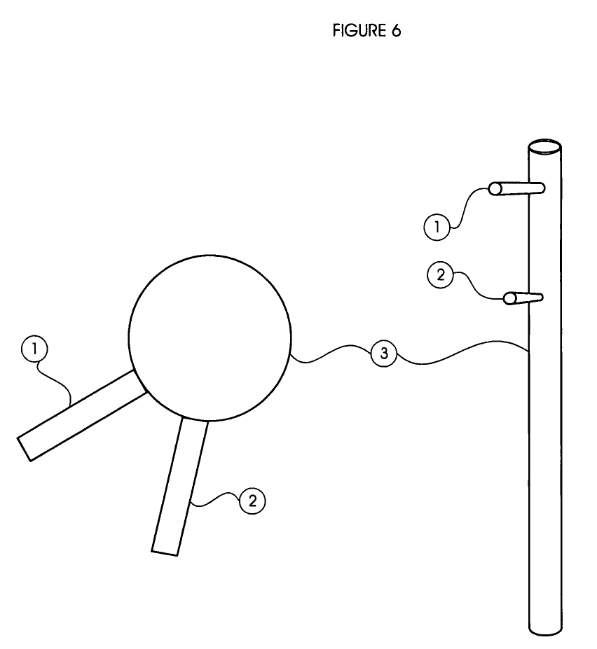

FIG. 6 is a top and perspective elevations of the pivotal vertical rod member 3, with a connected trigger support cross member 1, and a connected cross line guide member 2, of the present ice fishing apparatus.

As shown in the drawings, a unique ice fishing apparatus of the invention comprises a main support member FIG. 1B 9 with a rod base support member FIG. 1B 7 disposed transversely of said member and insertable thereto toward the rear of said member, a rod base hold down member FIG. 1B 8 disposed transversely and insertable thereto into the said base at the rear of said base, a trigger and release support member FIG. 1A 10 disposed transversely and insertable thereto into the front end of said member. The frontal trigger and release support member being comprised of a “C”-shaped support member, FIG. 1B 4, a pivotal vertical rod member FIG. 1B 1, with a connected trigger support cross member FIG. 1B 2, a connected cross line guide trigger member FIG. 1B 3, a vertical sleeve on the vertical pivotal rod member FIG. 1B 6, and a washer at the top of the vertical sleeve member FIG. 1B 5.

The handle of the rod and reel assembly is seated on the rod base support member, FIG. 2-1, and under the rod hold down member, FIG. 2-2.

The rod tip is urged downwards and placed beneath the trigger support member, FIG. 2-3. The fishing line is inserted into the ice hole and placed around and behind the cross line guide trigger member, FIG. 2-4.

When a fish takes the bait and hook in its mouth and attempts to swim away with the bait, it causes the fishing line to tighten and pull at the cross line guide member, FIG. 2-4. This causes the pivotal vertical rod member, FIG. 2-5 to pivot, thereby causing the trigger support member, FIG. 2-3 to turn away from the rod tip and releases the rod tip upward, thereby hooking the fish.

Once the hook is set, the fish cannot escape. When the fisher person notices that the rod is now in the released position and there is movement on the tip of the rod, the fisher person can now leisurely lift the rod out of its cradle and the fish can be reeled in. After the fish has been released from the hook, the hook can be rebaited and the apparatus can be reset in a matter of seconds.

The above description and drawings illustrate the uniqueness of this invention. The present invention provides novel and important advantages over existing ice fishing rigs. This apparatus automatically sets the hook allowing the fishing person enough time to attend to reeling in the catch. It does not require constant attention. This invention allows the fisher person the use of his or her favorite fishing rods and reels. By being able to reel in the catch, the fisher person is not restricted to a hand-over-hand retrieval method. Use of a reel also reduces the problematic line tangles, especially in wintry conditions where the line can get frozen to the ice or snagged on pieces of surrounding ice. Use of a reel is obviously advantageous when fishing at greater depths. Additionally, this apparatus can be manufactured and shipped economically. Often the fisher person introduces children to ice fishing. Children are typically not patient. They tend to wander about and are easily distracted. At the end of the day children generally do little fishing and are disappointed when they have caught nothing. This apparatus can be used so that a child can be called back to the apparatus when a fish has been hooked, and the child can reel in his own catch, making it a successful outing. These and other considerations make the fishing experience more enjoyable.

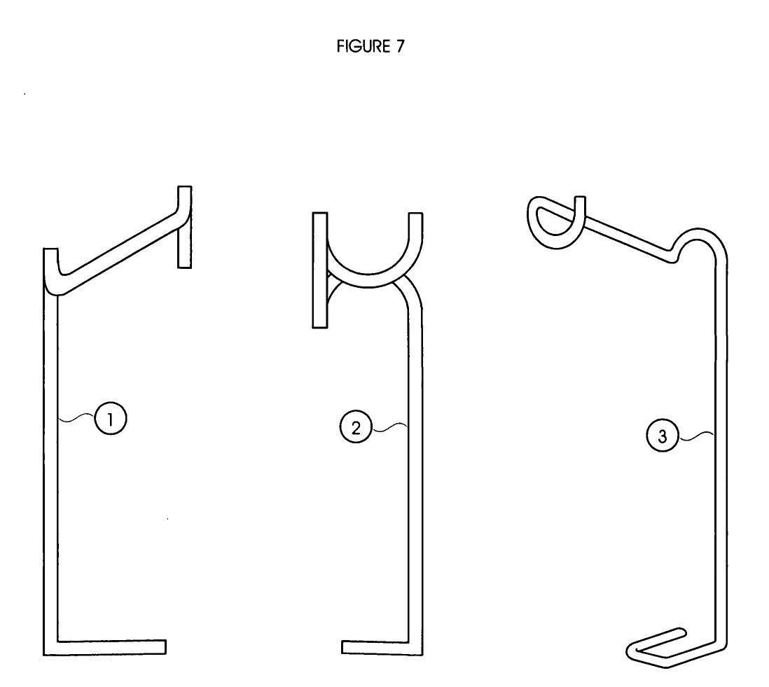

It will be obvious that various modifications may be made to this ice fishing apparatus described above and shown in the attached drawings within the scope of this invention. For example, the base support member can be made from a variety of materials, including wood or wood products, metal, plastic, vinyl, or other such materials, or a combination thereof, and may be finished or coated with a variety of substances including but not restricted to varnishes and labels. The vertical sleeve on the vertical pivotal rod member may be made of plastic or rubber or substituted by two or more “O”-rings made of rubber or other materials, or may be formed as part of the vertical rod member. The rod base support member and the rod base hold down member may be substituted for a single rod base saddle as illustrated in FIG. 7. Therefore the invention is to be limited only by the claims made.

### REFERENCES CITED

U.S. Patent Documents

| | | |
|---|---|---|
| 1488838 | April, 1924 | Savoie |
| 1996704 | April, 1935 | Hawkins |
| 2924038 | February, 1960 | Dahlgren |
| 3474561 | October, 1969 | McConkey |
| 4780979 | November, 1988 | Dyck |
| 4912870 | April, 1990 | Smoluk |

What is claimed is:

1. An ice fishing apparatus including a main base supporting member, a rod base support member disposed transversely of said member and insertable thereto toward the rear of said member, a rod base hold down member disposed transversely and insertable thereto into the said base at the rear of said base, a trigger and release support member disposed transversely and insertable thereto into the front end of said member. The frontal trigger and release support member being comprised of a “C”-shaped support member, a pivotal vertical rod member with a connected trigger support cross member, a connected cross line guide member, a vertical sleeve on the vertical pivotal rod member, and a washer at the top of the vertical sleeve member.

2. An ice fishing apparatus according to claim 1 wherein said frontal trigger and release support member is insertable into the main base member.

3. An ice fishing apparatus according to claim 1 wherein said rod base member is insertable toward the rear of said base member in two vertical holes in the base member and designed to support the frontal section of the rod base.

4. An ice fishing apparatus according to claim 1 wherein said rod base hold down member disposed transversely and insertable thereto into the said base at the rear of said base in two horizontal holes at the rear end of said base, and designed to hold down the rear end of said rod base when pressure is applied to the rod base by the rod and line and any fishing bait and any fish bite and any fish hooked.

5. An ice fishing apparatus according to claim 1 wherein the frontal trigger and release member is insertable into the front of the main base member and whereby the main vertical rod member is pivotally biased.

6. An ice fishing apparatus according to claim 1 wherein said biasing means is adjustable.

7. An ice fishing apparatus according to claim 1 wherein the sleeve member is attached to the rod member in order to hold the rod member in the frontal trigger and release member.

8. An ice fishing apparatus according to claim 1 wherein the washer is positioned on the vertical rod member and above the sleeve member and below the top portion of the frontal trigger and release member in order to allow the pivotal rod member to rotate freely.

9. An ice fishing apparatus according to claim 1 wherein the vertical biased rod member includes a horizontally attached arm-releasing member in a biased position when said arm-releasing member is triggered.

10. An ice fishing apparatus according to claim 1 wherein the vertical biased rod member includes a horizontally attached line position guide and trigger.
